(19) United States
(12) Patent Application Publication
(10) Pub. No.: US 2022/0059080 A1
(43) Pub. Date: Feb. 24, 2022

(54) REALISTIC ARTIFICIAL INTELLIGENCE-BASED VOICE ASSISTANT SYSTEM USING RELATIONSHIP SETTING

(71) Applicant: O2O CO., LTD., Chuncheon-si, Gangwon (KR)

(72) Inventors: Sung Min AHN, Seongnam-si, Gyeonggi-do (KR); Dong Gil PARK, Seongnam-si, Gyeonggi-do (KR)

(73) Assignee: O2O CO., LTD., Chuncheon-si, Gangwon-do (KR)

(21) Appl. No.: 17/418,843

(22) PCT Filed: Sep. 25, 2020
(86) PCT No.: PCT/KR2020/013054

§ 371 Date: Jun. 27, 2021

(30) Foreign Application Priority Data
Sep. 30, 2019 (KR) 10-2019-0120294

(51) Int. Cl. G10L 15/08; G10L 25/63; G10L 25/27; G06K 9/00

(52) U.S. Cl. CPC G10L 15/08; G10L 25/63; G10L 2015/088; G06K 9/00302; G06K 9/00335; G10L 25/27

(57) ABSTRACT

A voice conversation service is provided, wherein after user information is inputted and an initial response character according to recognition of a call word is set, when the call word or a voice command is inputted, the call word is recognized, the voice command is analyzed, an emotion of the user is identified through acoustic analysis, and a facial image of the user captured by a camera is recognized and a situation and emotion of the user are identified through gesture recognition, and thereafter, the initial response character set based on the recognized call word is set and displayed through a display unit, a voice conversation object and a surrounding environment are determined by setting a relationship between the voice command, user information, and emotion expression information, and after making the determined voice conversation object into a character, voice features are applied to provide a user-customized image and voice feedback.

### TECHNICAL FIELD

The present invention relates to a realistic artificial intelligence-based voice assistant system using relationship setting, and in particular, to a realistic artificial intelligence-based voice assistant system using relationship setting which generates an optimal voice conversation object corresponding to a voice command by relationship setting through user information input and provides a voice feature for each object to provide a more realistic and interesting voice conversation service.

### BACKGROUND ART

Recently, various artificial intelligence services using voice recognition technology have been released at home and abroad. The global market size of artificial intelligence speakers, which is a kind of artificial intelligence service, is expected to reach about 2.5 trillion won in 2020, and the related market size is expected to increase rapidly in the future.

In a general personal assistant service, a user's voice command is recognized as a text command using various voice recognition technologies, and then the user's voice command is processed according to the recognition result. Korean Laid-Open Patent Publication No. 2003-0033890 discloses a system that provides a personal assistant service using such a voice recognition technology.

Such a general personal assistant service converts the voice command into text through the meaning of words included in the user's voice command, recognizes only information as a command, and does not recognize the user's emotions. Therefore, the response of a mobile personal assistant service is the same regardless of the user's emotions such as sadness, anger, and joy.

The general mobile personal assistant service as described above may feel dry to the user, which has a problem that interest in use may be quickly lost. As a result, there is a problem that the frequency of use of the user decreases and the usage needs of the user decreases.

In order to improve problems of such a general mobile personal assistant service, technologies proposed in the related art are disclosed in <Patent Document 1> and <Patent Document 2> below.

The related art disclosed in <Patent Document 1> provides a customized deceased remembrance system based on a virtual reality that may interact with the deceased through the voice and image of the deceased as well as realizes the place where the deceased usually lived or the space where the deceased may be remembered in the virtual reality.

The related art uses the setting of relationship between the user and the deceased, but only uses the setting of the relationship with the deceased registered in advance, and does not grasp the user's emotions to provide the optimal response object, and thus, there is a disadvantage that it is impossible to grasp the user's interest by analyzing an application installed on a user terminal.

In addition, the related art disclosed in <Patent Document 2> provides a mobile terminal that stores information on the appearance of characters displayed for each state of the mobile terminal in a memory in plural and displays various characters and the like according to the user's taste or age on a background screen (i.e., a standby screen or an idle screen) of a display.

This related art may express changes in the character's facial expression according to a battery status, connection status, reception status, operation status, etc. on the display of the mobile terminal in various appearances, but there is a disadvantage that it is impossible to set a relationship through user information input and it is impossible to generate an optimal response object corresponding to a voice command.

### RELATED ART LITERATURE

### Patent Literature

(Patent Document 1) Korean Laid-open Patent Application No. 10-2019-0014895 (published on Feb. 13, 2019) (The deceased remembrance system based on virtual reality)

(Patent Document 2) Korean Laid-open Patent Application No. 10-2008-0078333 (published on Aug. 27, 2008) (Mobile device having changable character on background screen in accordance of condition thereof and control method thereof).

### DISCLOSURE

### Technical Problem

Therefore, the present invention has been proposed to solve various problems caused by the related art as described above, and an object of the present invention is to provide a realistic artificial intelligence-based voice assistant system using relationship setting that enables the generation of an optimal voice conversation object corresponding to a voice command by relationship setting through user information input.

Another object of the present invention is to provide a realistic artificial intelligence-based voice assistant system using relationship setting that provides a more realistic and interesting voice conversation service by providing voice features for each object.

Still another object of the present invention is to provide a realistic artificial intelligence-based voice assistant system using relationship setting that when a wake-up signal is invoked, the entire display screen is not converted to a voice command standby screen but is converted to a pop-up window form to enable multitasking during voice conversation.

### Technical Solution

In order to achieve the above object, an “realistic artificial intelligence-based voice assistant system using relationship setting” according to the present invention includes: a user basic information input unit that inputs user information and setting an initial response character according to call word recognition; a call word setting unit that sets a voice command call word; a voice command analysis unit that analyzes a voice command uttered by the user and grasps the user's emotions through sound analysis; an image processing unit that recognizes the user's facial image captured through a camera and grasps the user's situation and emotions through gesture recognition; and a relationship setting unit that learns image information based on user interest information and a voice command keyword acquired from the user basic information input unit by a machine learning algorithm to derive a voice conversation object, applies a voice feature matched to the derived voice conversation object and reflects an emotional state of the user acquired from the image processing unit to characterize the voice conversation object, and outputs a user-customized image and voice feedback.

The relationship setting unit includes an object candidate group derivation unit and a surrounding environment candidate group derivation unit that derive an object candidate group and a surrounding environment candidate group that match the acquired voice command, and an object and surrounding environment determination unit that determines a final voice conversation object and a surrounding environment through artificial intelligence learning of the object candidate group and the surrounding environment candidate group based on the user information.

The object and surrounding environment determination unit determines the voice conversation object through artificial intelligence learning and preferentially determines a voice conversation object having a high preference by the same age and the same gender as the user.

The relationship setting unit applies a preset basic voice feature to output the voice feedback when the voice feature of the determined voice conversation object does not exist in a voice database.

When the user requests a character change through the input unit in a state in which a character of the determined voice conversation object is expressed through a display unit, the relationship setting unit changes the relationship setting through a person related to the voice conversation object to newly generate the voice conversation object.

The relationship setting unit includes an object emotional expression determination unit that determines an emotional expression of the voice conversation object determined based on situation information and emotion information of the user acquired from the image processing unit.

The relationship setting unit recognizes the voice feature of the user through the call word recognition and displays an initial response object on the display unit in full screen or displays the initial response object in a pop-up form when a call word is recognized to implement multitasking during voice conversation.

### Advantageous Effects

According to the present invention, there is an effect that an optimal voice conversation object corresponding to a voice command can be generated by relationship setting through user information input.

In addition, according to the present invention, there is also an effect of providing a voice feature for each object to provide a more realistic and interesting voice conversation service.

In addition, according to the present invention, when a wake-up signal is invoked, the entire display screen is not converted to a voice command standby screen, but is converted to a pop-up window form, and thus there is also an effect of achieving multitasking during voice conversation.

### DESCRIPTION OF DRAWINGS

FIG. 1 is a block diagram of a realistic artificial intelligence-based voice assistant system using relationship setting according to the present invention.

FIG. 2 is a block diagram of an example of a relationship setting unit of FIG. 1.

FIG. 3 is an exemplary view of a realistic AI assistant selection screen in the present invention.

FIG. 4 is a first exemplary view displaying a screen of an initial response character when recognizing a call word in the present invention.

FIG. 5 is a second exemplary view displaying a screen of an initial response character when recognizing a call word in the present invention.

FIG. 6 is an exemplary view of relationship setting in the present invention.

FIG. 7 is an exemplary view of a character generated through relationship setting and emotional expression in the present invention.

FIG. 8 is an exemplary view of a voice and image feedback screen according to a user's voice command in the present invention.

### DESCRIPTION OF REFERENCE NUMERALS

101: User basic information input unit 102: Microphone

103: Voice preprocessing unit 104: Call word setting unit

105: Voice command analysis unit 106: Camera

107: Image processing unit 108: Relationship setting unit

109: Object database (DB) 110: Environment information database

111: Voice database 112: Display unit

113: Speaker 114: GPS module

115: Storage unit 121: User information acquisition unit

122: Object candidate group derivation unit 123: Surrounding environment candidate group derivation unit

124: Object and surrounding environment determination unit 125: Object emotion expression determination unit

126: Voice feature search unit 127: Customized image and response voice output unit

### MODES OF THE INVENTION

Hereinafter, a realistic artificial intelligence-based voice assistant system using relationship setting according to a preferred embodiment of the present invention will be described in detail with reference to the accompanying drawings.

The terms or words used in the present invention described below should not be construed as being limited to a conventional or dictionary meaning, and the inventor should appropriately define the concept of terms in order to describe his own invention in the best way. It should be interpreted as a meaning and concept consistent with the technical idea of the present invention based on the principle that it can be.

Therefore, the embodiments described in the present specification and the configurations shown in the drawings are only preferred embodiments of the present invention, and do not represent all the technical ideas of the present invention, and various equivalents and equivalents that can replace them at the time of the present application It should be understood that there may be variations.

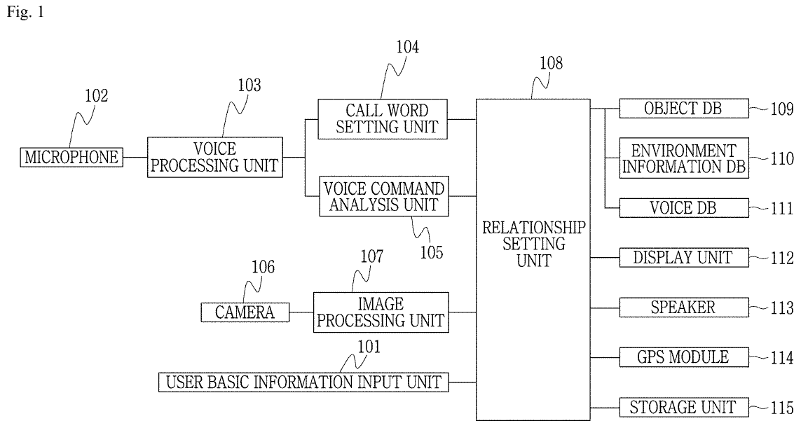

FIG. 1 is a block diagram of a realistic artificial intelligence-based voice assistant system using relationship setting according to a preferred embodiment of the present invention, the realistic artificial intelligence-based voice assistant system using the relationship setting includes a user basic information input unit 101, a microphone 102, a voice preprocessing unit 103, a call word setting unit 104, a voice command analysis unit 105, a camera 106, an image processing unit 107, a relationship setting unit 108, an object database (DB) 109, an environment information database (DB) 110, a voice database (DB) 111, a display unit 112, a speaker 113, and a GPS module 114.

The user basic information input unit 101 refers to an input device such as a keypad that inputs user information and sets an initial response character according to call word recognition.

The microphone 102 is a device for receiving a user's voice, and the voice preprocessing unit 103 pre-processes the voice input through the microphone 102 to output an end point and a feature of the voice.

The call word setting unit 104 serves to set a voice command call word, and the voice command analysis unit 105 serves to analyze a voice command uttered from the user transmitted through the voice preprocessing unit 103 and to grasp the user's emotions through sound analysis.

The camera 106 serves to capture the user's image and a gesture, and the image processing unit 107 serves to recognize the user's facial image captured through the camera 106 and to grasp the user's situation and emotions through gesture recognition.

The object database 109 serves to store a voice conversation object candidate group and a realistic artificial intelligence (AI) assistant character matched to the voice command input by the user, and the environment information database 110 serves to store surrounding environment information corresponding to the object candidate group, and the voice database 111 serves to store voice feature information of a derived voice conversation object.

The display unit 112 serves to display an initial response screen according to call word recognition and to display an expression image and gesture information of the voice conversation object on the screen. The display unit 112 displays a response screen in which the voice conversation object according to the call word recognition is displayed in a pop-up window form to implement a multitasking screen during voice conversation.

The speaker 113 serves to output a response voice, and the GPS module 114 serves to acquire time and location information through an artificial satellite.

The relationship setting unit 108 servers to set an initial response character set based on the call word recognized through the call word recognition unit 104 to display the character through the display unit 112, to learn image information based on user interest information and a voice command keyword acquired from the user basic information input unit 101 by a machine learning algorithm to derive a voice conversation object, to apply a voice feature matched to the derived voice conversation object and reflect an emotional state of the user acquired from the image processing unit to characterize the voice conversation object, and to output a user-customized image and voice feedback.

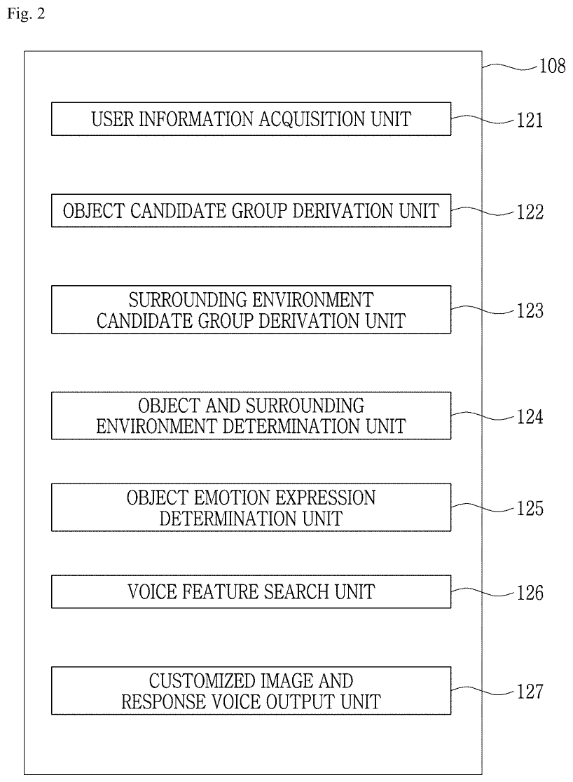

As shown in FIG. 2, the relationship setting unit 108 may include a user information acquisition unit 121 that acquires basic information of the user through the input unit 101 and analyzes an application owned by the user to acquire interest information for grasping interests of the user, an object candidate group derivation unit 122 that searches for an object candidate group matching an acquired voice command from the object database 109, and a surrounding environment candidate group derivation unit 123 that searches for a surrounding environment candidate group corresponding to a candidate group derived from the object candidate group derivation unit 122 from the environment information database 110.

In addition, the relationship setting unit 108 may further include an object and surrounding environment determination unit 124 that determines a final voice conversation object and a surrounding environment through artificial intelligence learning of the object candidate group and the surrounding environment candidate group based on user information. The object and surrounding environment determination unit 124 may determine the voice conversation object through artificial intelligence learning and preferentially determines a voice conversation object having a high preference by the same age group and the same gender group as the user.

In addition, the relationship setting unit 108 may further include a voice feature search unit 126 that extracts the voice feature of the determined voice conversation object from the voice database 111. When the voice feature of the voice conversation object does not exist in the voice database, the voice feature search unit 126 applies a preset voice feature through the search of the voice database 111.

In addition, the relationship setting unit 108 may further include an object emotion expression determination unit 125 that determines an emotional expression of the object determined based on situation information and emotion information of the user acquired from the image processing unit 107 and a customized image and response voice output unit 127 that characterizes the determined voice conversation object and outputs a user-customized image and a response voice including a surrounding environment corresponding to the determined voice conversation object.

The realistic artificial intelligence-based voice assistant system using relationship setting implemented as described above may be implemented using a smartphone used by the user or implemented using an AI speaker. In the present invention, it is assumed that the smartphone is used, but it will be apparent to those of ordinary skill in the art that the present invention is not limited thereto.

An operation of the realistic artificial intelligence-based voice assistant system using relationship setting according to a preferred embodiment of the present invention configured as described above will be described in detail with reference to the accompanying drawings.

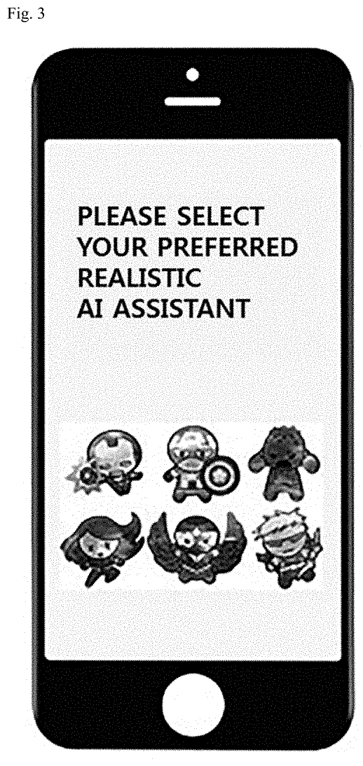

First, the user inputs basic information of the user through the user basic information input unit 101. Here, the basic information may include age, gender, blood type, work, hobbies, preferred food, preferred color, favorite celebrity, preferred brand, and the like. In addition, a call word response initial screen is set. When the initial response character according to the call word recognition is set, the initial response character is displayed through the display unit 112 on the call word response initial screen. FIG. 3 is an example of a screen that sets the initial response character for setting the call word response initial screen. In the initial response character screen as shown in FIG. 3, the user selects the initial response character according to the call word recognition through the user basic information input unit 101. The selected initial response character is stored in the storage unit 115 through the relationship setting unit 108.

Next, the user selects a call word setting item through the user basic information input unit 101. When the call word setting item is selected, the relationship setting unit 108 displays a screen to tell the call word to be used through the display unit 112. Thereafter, the user inputs a call word for invoking a voice assistant service through the microphone 102. The input call word voice is preprocessed for voice recognition through the voice preprocessing unit 103. Here, the voice preprocessing refers to performing endpoint detection, feature detection, and the like, which are performed in conventional voice recognition. Subsequently, the call word setting unit 104 recognizes the call word as voice recognition using the endpoint and the feature preprocessed by the voice preprocessing unit 103 and transfers the recognized call word information to the relationship setting unit 108. Here, for voice recognition, a generally known voice recognition technology may be used. When the call word is recognized, the recognition relationship setting unit 108 induces the user to input the call word once more through the display unit 112 in order to grasp the feature of the user's voice, and when the call word is input, the call word is recognized through a process of the call word recognition as described above. When the call word is recognized, the relationship setting unit 108 displays the recognized call word through the display unit 112 and confirms whether the call word is correct. When the user inputs a voice that the call word is correct, the recognized call word is registered in the storage unit 115 as a final call word.

Through this process, in a state in which a basic process for implementing the voice assistant service is completed, when an actual user inputs the call word through the microphone 102 to use the voice assistant service, the call word recognition is sequentially performed through the voice preprocessing unit 103 and the call word setting unit 104.

The relationship setting unit 108 compares the call word set through the call word setting unit 104 with the call word stored in the storage unit 115, and when they match, the relationship setting unit 108 extracts the initial response character stored in the storage unit 115 and displays the initial response character through the display unit 112 and converts to a voice command standby screen.

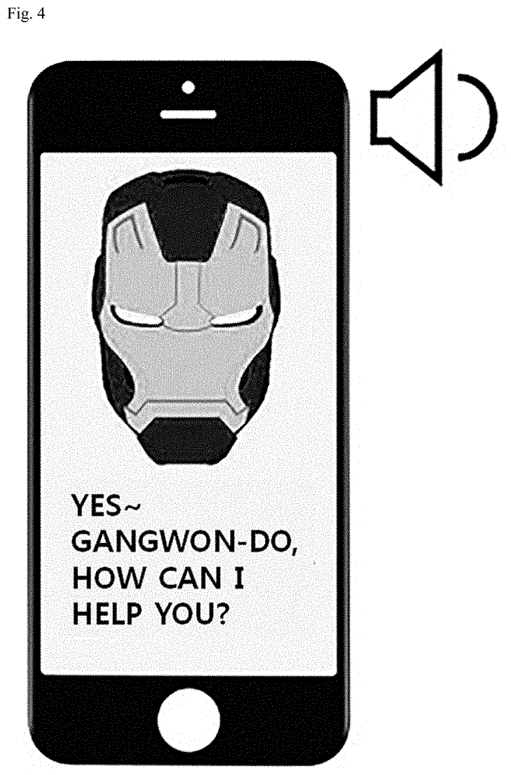

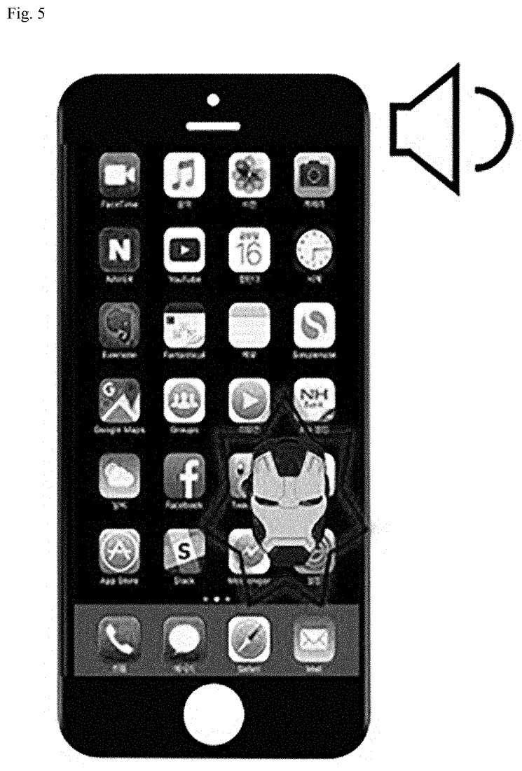

Here, the initial response character may be displayed in a method of displaying the initial response character on the entire screen as shown in FIG. 4 and in a pop-up form as shown in FIG. 5. When the initial response character is displayed on the entire screen and the screen is converted to the voice command standby screen, other works become unavailable. Although the above two screens may be used as the voice command standby screen, it is preferable to display the initial response character in the pop-up form as shown in FIG. 5 so that the user may perform multitasking during a voice conversation service.

Subsequently, when the user issues a voice command in the voice command standby screen state, the voice command is transmitted to the voice command analysis unit 105 sequentially via the microphone 102 and the voice preprocessing unit 103. The voice command analysis unit 105 analyzes the voice command based on the endpoint and feature preprocessed by the voice preprocessing unit 103 and grasps the user's emotion through sound analysis. Here, the voice command analysis unit 105 analyzes tone, speed, and pitch (pitch height) information compared with the usual voice information of the input command sound to infer the user's emotion.

Next, the image processing unit 107 analyzes a user's image (especially, a facial image) and gestures captured through the camera 106 to grasp the user's situation and emotions during the voice assistant service. Here, the camera 106 and the image processing unit 107 are automatically activated at the same time as a voice recognition operation during the voice assistant service according to the call word recognition. For facial expression recognition or gesture recognition of the facial image, facial expression recognition or gesture recognition is performed by directly adopting an image recognition technique and a gesture recognition technique known in the art.

Subsequently, the relationship setting unit 108 sets an initial response character set based on the call word set through the call word setting unit 104 to display the character through the display unit 112, learns image information based on user interest information and a voice command keyword acquired from the user basic information input unit 101 by a machine learning algorithm to derive a voice conversation object, applies a voice feature matched to the derived voice conversation object and reflects an emotional state of the user acquired from the image processing unit 107 to characterize the voice conversation object, and output a user-customized image and voice feedback.

That is, the object candidate group derivation unit 122 searches for an object candidate group matching the user information and the acquired voice command from the object database 109 to derive the object candidate group. Here, the types of object candidate groups are diverse, such as friends, lovers, politicians, entertainers, celebrities, educators, and companion animals.

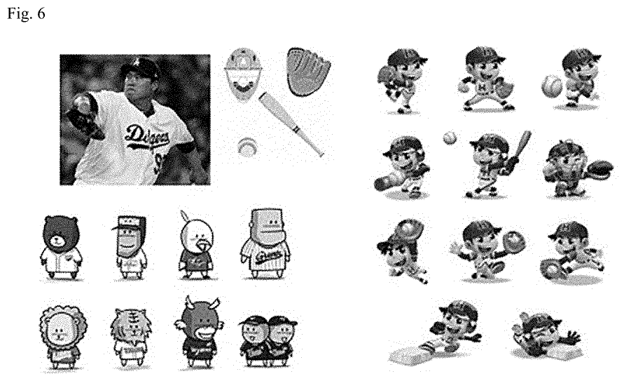

In addition, the surrounding environment candidate group derivation unit 123 searches for and derives the surrounding environment candidate group corresponding to the candidate group derived from the object candidate group derivation unit 122 from the environment information database 110. Here, the surrounding environment candidate group is extracted from surrounding environment information set in advance to correspond to the object candidate group, and when the object candidate is a professional baseball player, it may be information related to baseball, when the object candidate is an entertainer, it may be a product advertised by the corresponding entertainer, and when the object candidate is a chef, it may be various types of food that represent the corresponding chef. FIG. 6 is an example of the object candidate group and the surrounding environment candidate group corresponding thereto.

In a state in which the object candidate group and the surrounding environment candidate group according to the voice command and the user information are derived, the object and surrounding environment determination unit 124 learns the object candidate group and the surrounding environment candidate group based on the user information using an artificial intelligence algorithm to determine a final voice conversation object and surrounding environment. Here, for artificial intelligence learning, machine learning algorithms and deep-learning algorithms well known in the art may be used. Machine learning or deep-learning is an artificial intelligence (AI) algorithm that inputs a variety of information to acquire optimal results. When determining a voice conversation object through artificial intelligence learning, it is preferable to preferentially determine a voice conversation object having a high preference by the same age group and the same gender group as the user.

Next, the object emotion expression determination unit 125 determines the emotional expression of the voice conversation object determined based on the user's situation information and emotion information acquired from the image processing unit 107. That is, when the user's facial image is a smile, it is inferred that the user is currently in a comfortable emotional state, and the emotion expression is determined so that the emotion of the voice conversation object is also in a comfortable state.

In addition, the voice feature search unit 126 searches the voice database 111 to extract the voice feature of the finally determined voice conversation object. Here, the voice feature refers to characteristics such as a tone or dialect. When the voice feature of the voice conversation object does not exist in the voice database 111, the voice feature search unit 126 applies a preset basic voice through the search of the voice database 111.

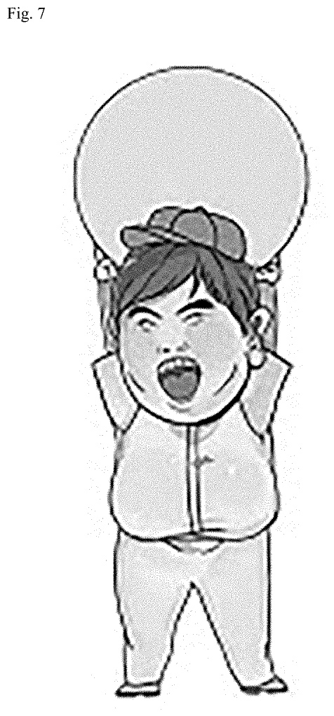

Thereafter, the customized image and response voice output unit 127 applies the emotion expression to the determined voice conversation object to characterize it. FIG. 7 is an example of expressing a voice conversation object including emotional expression. Since the user's emotional expression is in a comfortable state, the characterized voice conversation object is also expressed in a comfortable state.

Subsequently, the extracted voice feature is applied to the character of the determined voice conversation object to output the user-customized image and voice. The response character is displayed through the display unit 112, and the voice is transmitted through the speaker 113.

Accordingly, the character of the voice conversation object determined in response to the voice command expresses the same emotion as that containing his or her current emotion, and a voice including the voice feature (tone) of the determined character is transmitted to respond to the voice command, and accordingly, the voice assistant service is implemented through the optimal customized image and voice.

Meanwhile, in a state in which the character of the determined voice conversation object is displayed through the display unit 112, when the user is not satisfied with the output voice conversation object, the user requests a character change through the user basic information input unit 101. When the change of the voice conversation object is requested, the customized image and response voice output unit 127 changes the relationship setting through a person related to the voice conversation object. Here, when the relationship setting is changed, the voice conversation object is also changed.

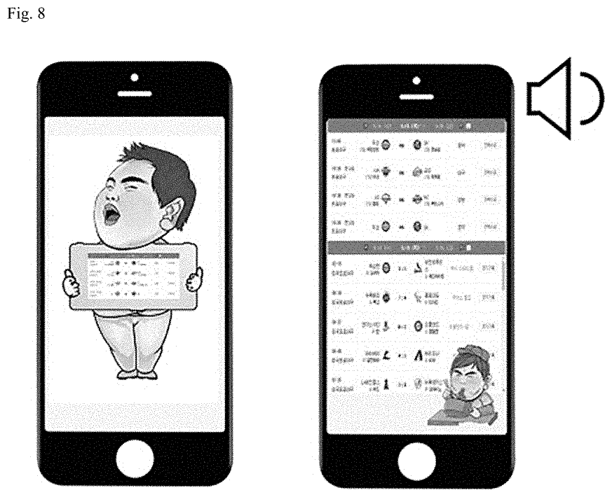

While receiving the voice assistant service according to the voice command through the object character through the display unit 112, when the user touches a specific portion of the image displayed on the screen, information related to the touched specific portion is displayed on the entire display screen. At this time, the voice conversation object is converted to a pop-up form to be in a voice command standby state. FIG. 8 is an example of a screen showing the voice command standby state by converting the voice conversation object to the pop-up form in a state in which the specific portion of the screen is selected in the voice assistant service state and the information related to the touched specific portion is displayed on the entire screen.

Meanwhile, when implementing the voice assistant service through the relationship setting as described above, as a result of analyzing the voice command, when surrounding geographic information is required, current location information is extracted through the GPS module 114. Subsequently, the voice assistant service may be implemented by searching for map data based on the location information acquired when providing the surrounding environment information and by providing the surrounding geographic information. This may be usefully used when the user issues a voice command to find a place such as a restaurant.

As described above, the present invention generates an optimal voice conversation object corresponding to a voice command by relationship setting through user information input and characterizes the object, and it is possible to provide a voice feature for each character to provide a more realistic and interesting voice conversation service.

Although the invention made by the present inventor has been described in detail according to the above embodiment, the present invention is not limited to the above embodiment, and it is common knowledge in the art that various changes can be made without departing from the gist of the invention. It will be obvious to those with ordinary knowledge in this technical field.

1. A realistic artificial intelligence-based voice assistant system using relationship setting as a system capable of providing a realistic artificial intelligence (AI) voice assistant using relationship setting, the system comprising:
a user basic information input unit that inputs user information and setting an initial response character according to call word recognition;
a call word setting unit that sets a voice command call word;
a voice command analysis unit that analyzes a voice command uttered by a user and grasps the user's emotions through sound analysis;
an image processing unit that recognizes the user's facial image captured through a camera and grasps the user's situation and emotions through gesture recognition; and
a relationship setting unit that learns image information based on user interest information and a voice command keyword acquired from the user basic information input unit by a machine learning algorithm to derive a voice conversation object, applies a voice feature matched to the derived voice conversation object and reflects an emotional state of the user acquired from the image processing unit to characterize the voice conversation object, and outputs a user-customized image and voice feedback.

2. The system of claim 1, wherein the relationship setting unit includes an object candidate group derivation unit and a surrounding environment candidate group derivation unit that derive an object candidate group and a surrounding environment candidate group that match the acquired voice command, and an object and surrounding environment determination unit that determines a final voice conversation object and a surrounding environment through artificial intelligence learning of the object candidate group and the surrounding environment candidate group based on the user information.

3. The system of claim 2, wherein the object and surrounding environment determination unit determines the voice conversation object through artificial intelligence learning and preferentially determines a voice conversation object having a high preference by the same age group and the same gender group as the user.

4. The system of claim 1, wherein the relationship setting unit applies a preset basic voice feature to output the voice feedback when the voice feature of the determined voice conversation object does not exist in a voice database.

5. The system of claim 1, wherein when the user requests a character change through the input unit in a state in which a character of the determined voice conversation object is expressed through a display unit, the relationship setting unit changes the relationship setting through a person related to the voice conversation object to newly generate the voice conversation object.

6. The system of claim 1, wherein the relationship setting unit includes an object emotion expression determination unit that determines an emotional expression of the voice conversation object determined based on situation information and emotion information of the user acquired from the image processing unit.

7. The system of claim 1, wherein the relationship setting unit recognizes the voice feature of the user through the call word recognition and displays an initial response object on the display unit in full screen or displays the initial response object in a pop-up form when a call word is recognized to implement multitasking during voice conversation.
